(19) United States
(12) Patent Application Publication
(10) Pub. No.: US 2005/0010943 A1
(43) Pub. Date: Jan. 13, 2005

(54) NON-CONTACT CLAMPING MECHANISM FOR USE IN AN OPTICAL DISK DRIVE

(76) Inventor: Chun-Lung Ho, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/709,941

(22) Filed: Jun. 8, 2004

(30) Foreign Application Priority Data
Jul. 9, 2003 (TW) 092212532

(51) Int. Cl. G11B 17/03; G11B 17/04; G11B 17/08

(52) U.S. Cl. 720/710

(57) ABSTRACT

A non-contact clamping mechanism for use in an optical disk drive including a turntable includes an upper cover including a first hole, a clamping device installed above the first hole of the upper cover for combining with the turntable so as to fix an optical disk, an upper plate for covering the first hole of the upper cover to prevent the clamping device from departing from the optical disk drive when reading the optical disk, and a magnetic element attached to the upper plate for providing a real-time preload to the clamping device.

### BACKGROUND OF INVENTION

1. Field of the Invention

The present invention relates to a non-contact clamping mechanism for use in an optical disk drive, and more particularly, to a non-contact clamping mechanism capable of generating a real-time preload to a clamping device used in an optical disk drive.

2. Description of the Prior Art

Owing to the recent progress of computer technology, prices of optical disk drives are becoming lower. And the optical storage devices are becoming more and more popular. Optical disk drives read data stored on optical disks by utilizing optical principles. First of all, an optical disk is held on a turntable of a spindle motor of the optical disk drive by a clamping mechanism. The clamping mechanism can fix and release the optical disk precisely so that the optical disk can be positioned and ejected smoothly. Thus the clamping mechanism is a very important mechanism of the optical disk drive.

Please refer to FIG. 1. FIG. 1 is a perspective diagram of components of a conventional clamping mechanism for use in an optical disk drive of the prior art. The conventional clamping mechanism includes an upper plate 1, a clamping yoke 2, a magnetic element 3, a clamping body 4, and an upper covering 5 having a first hole 5a. Furthermore, FIG. 2 is an exploded assembly drawing of the conventional clamping mechanism of the prior art. The clamping yoke 2 includes a second hole 2a and a plurality of slots 2b around the second hole 2a. The magnetic element 3 includes a third hole 3a to cooperate with a metal or a magnetic element deposed on a turntable (not shown) to provide a magnetic force that pushes the clamping body toward the turntable. The shape of the clamping body 4 is cylindrical, and the outer diameter of the clamping body 4 is greater than the diameter of the first hole 5a on the upper covering 5 so that the clamping body 4 can be suspended above the first hole 5a on the upper covering 5. The clamping body 4 includes a protruding structure 4a, a plurality of hooks 4b, and a hub 4c of conical shape for securing a central hole of the optical disk to combine with the turntable of the optical disk drive so as to fix the optical disk.

The assembly of the combination of the clamping yoke 2, the magnetic element 3, and the clamping body 4 is called a clamping device 10. Please refer to FIG. 2 and FIG. 3. FIG. 3 is a top view of the OLE_LINK1 clamping device 10 OLE_LINK1 of the prior art. The clamping yoke 2 and the magnetic element 3 can be put together by aligning the second hole 2a of the clamping yoke 2 with the third hole 3a of the magnetic element 3. The clamping yoke 2 and the magnetic element 3 can be fit onto the protruding structure 4a of the clamping body 4, and then a clamping device 10 can be assembled by wedging the plurality of slots 2b of the clamping yoke 2 into the plurality of hooks 4b of the clamping body 4. To understand the clamping mechanism of the prior art more clearly, please further refer to FIG. 4 and FIG. 5. FIG. 4 is a bottom view of the clamping device 10 of the prior art. FIG. 5 is a side view of the clamping device 10 of the prior art.

After the optical disk is loaded into the optical disk drive by way of a tray, the turntable of the optical disk drive can be elevated to a specific position. At this time, a magnetic element deposed on the turntable can attract the magnetic element 3 of the clamping device 10 for fixing the optical disk. Moreover, the plane of the rim of the first hole 5a is lower than the plane of the upper covering 5 and together with the upper plate 1 forming a chamber for deposing the clamping device 10. Since the outer diameter of the clamping device 10 is greater than the diameter of the first hole 5a on the upper covering 5, and the clamping device 10 can be positioned into the first hole 5a on the upper covering 5 and the clamping body 4 can be suspended from the rim of the first hole 5a. And then the upper plate 1 can cover the first hole 5a on the upper covering 5 to prevent the clamping device 10 from departing from the optical disk drive when the optical disk drive is operating.

When the optical disk drive with a disk loaded suffers an external impact, the attractive force between the clamping device 10 and the turntable cannot withstand the sudden impact energy so that the clamping device departs from the turntable. Thus, the optical disk cannot be fixed appropriately and result in that the optical disk bounces and is scraped so that the data on the optical disk might become damaged.

### SUMMARY OF INVENTION

It is therefore a primary objective of the claimed invention to provide a non-contact clamping mechanism for use in an optical disk drive to solve the above-mentioned problems.

Another object of the claimed invention is to provide a real-time preload to the clamping device for use in an optical disk drive to strengthen the clamping force between the clamping device and the turntable.

According to the claimed invention, a non-contact clamping mechanism for use in an optical disk drive including a turntable includes an upper cover with a first hole, a clamping device installed above the first hole of the upper cover for combining with the turntable so as to fix an optical disk, an upper plate for covering the first hole of the upper cover to prevent the clamping device from departing from the optical disk drive when reading the optical disk, and a magnetic element attached to the upper plate for providing a real-time preload to the clamping device.

According to the claimed invention, a non-contact clamping mechanism for use in an optical disk drive including a turntable includes an upper cover with a first hole, a clamp yoke having a second hole, a first magnetic element, a clamp body installed above the first hole of the upper cover for combining with the clamp yoke and the first magnetic element and combining with the turntable so as to fix an optical disk, a second magnetic element connected to the clamp body, an upper plate for covering the first hole of the upper cover to prevent the clamp body from departing from the optical disk drive when reading the optical disk, and a magnetic element attached to the upper plate for providing a real-time preload to the clamp body.

According to the claimed invention, a clamping device for use in a non-contact clamping mechanism to work with a turntable for fixing a disk in a disk drive is proposed. The disk drive includes a magnetic element attached to an upper cover. The clamping device includes a clamp body, and a first magnetic element deposed in the clamp body for generating a mutually repulsive force between the magnetic element and the first magnetic element to provide a real-time preload to the clamping device.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a perspective diagram of components of a conventional clamping mechanism for use in an optical disk drive of the prior art.

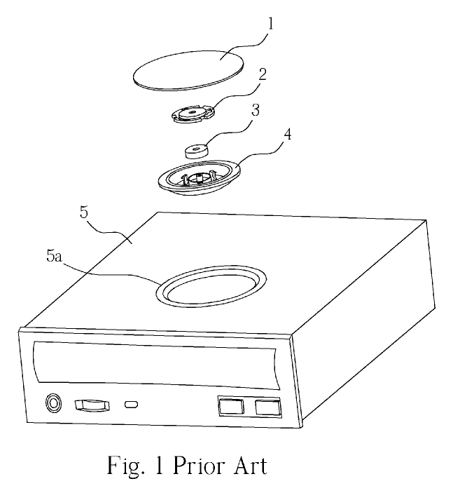

FIG. 2 is an exploded assembly drawing of the conventional clamping mechanism of the prior art.

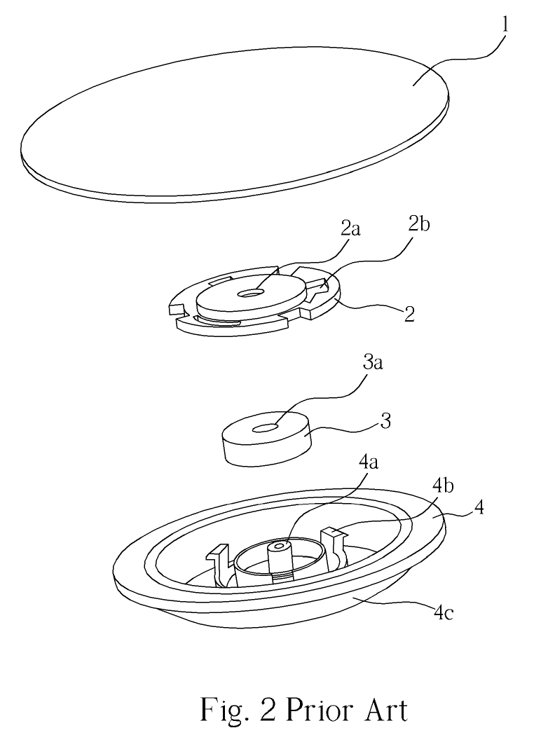

FIG. 3 is a top view of a clamping device of the prior art.

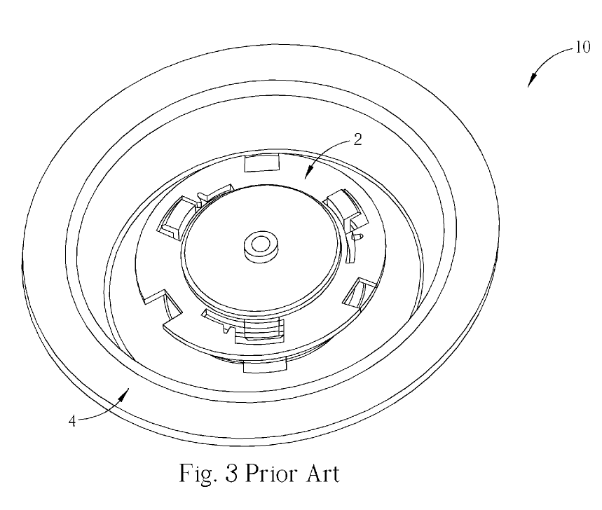

FIG. 4 is a bottom view of the clamping device of the prior art.

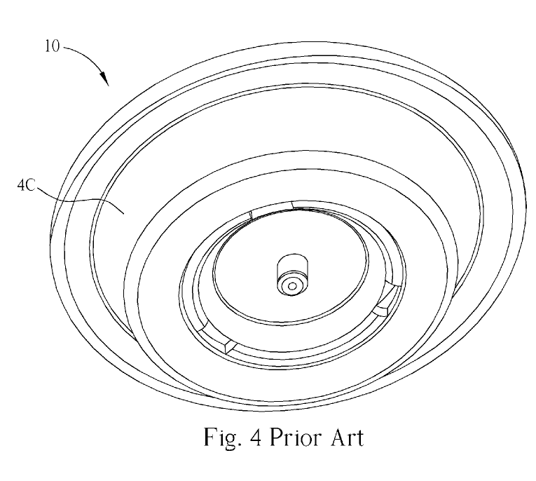

FIG. 5 is a side view of the clamping device of the prior art.

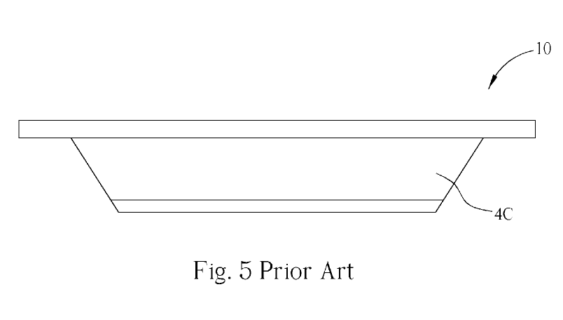

FIG. 6 is a perspective diagram of components of a non-contact clamping mechanism according to the present invention.

FIG. 7 is an exploded assembly drawing of the non-contact clamping mechanism according to the present invention.

FIG. 8 is a top view of a clamping device according to the present invention.

FIG. 9 is a bottom view of the clamping device according to the present invention.

FIG. 10 is a side view of the clamping device according to the present invention.

FIG. 11 is a diagram illustrating a mutually repulsive force between the clamping device and a second magnetic element.

### DETAILED DESCRIPTION

The embodiments according to the present invention are related to a half-height optical disk drive. Additionally, the present invention can be used in all kinds of optical disk drives including CD-ROM, CD-RW, slim-type drives, combo drives, DVD-R/RW, external drives, optical players, and so on.

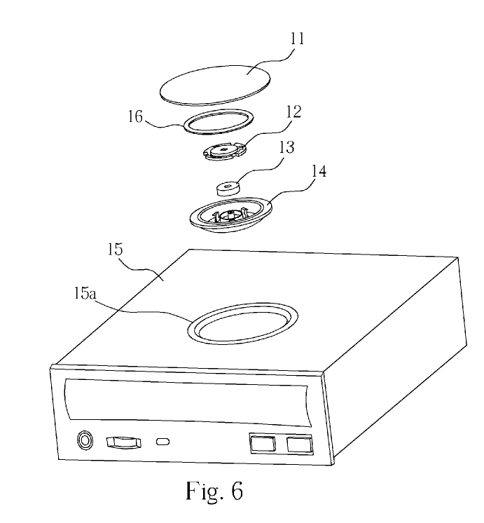

Please refer to FIG. 6. FIG. 6 is a perspective diagram of components of a non-contact clamping mechanism according to the present invention. The non-contact clamping mechanism includes an upper plate 11, a clamp yoke 12, a clamp body 14, an upper cover 15, a first magnetic element 13 in the form of a circular ring, and a second magnetic element 16 in the form of a circular ring. The first magnetic element 13 and the second magnetic element 16 can be magnets or other components made of magnetic material. The upper cover 15 has a first hole 15a. The assembly of the combination of the clamping yoke 12, the first magnetic element 13, and the clamping body 14 is called a clamping device. The clamping device cooperates with a metal or a magnetic element deposed on a turntable (not shown) to provide a force that pushes the clamping body toward the turntable. Furthermore, the second magnetic element 16 also provides a force to pushes the clamping body toward the turntable.

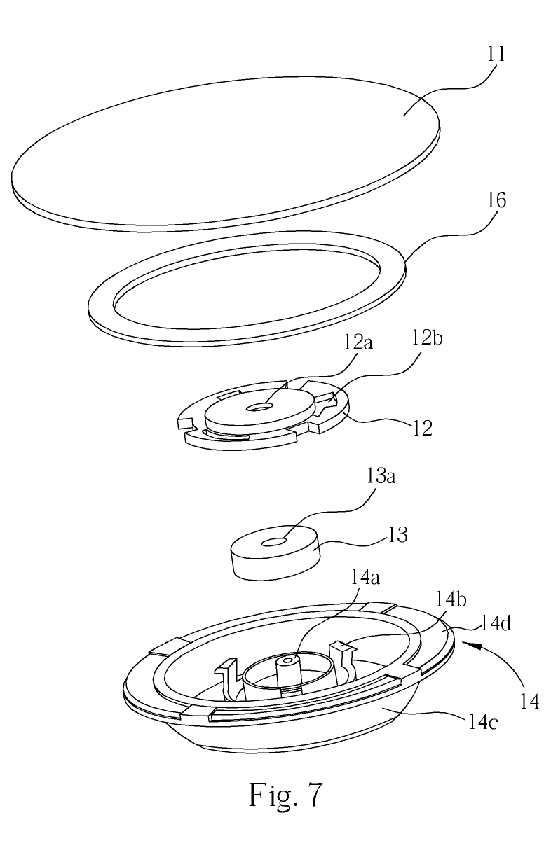

Please refer to FIG. 7. FIG. 7 is an exploded assembly drawing of the non-contact clamping mechanism according to the present invention. The clamp yoke 12 includes a second hole 12a and a plurality of a plurality of slots 12b around the second hole 12a. The first magnetic element 13 includes a third hole 13a. The shape of the clamp body 14 is cylindrical, and the outer diameter of the clamp body 14 is greater than the diameter of the first hole 15a on the upper cover 15 so that the clamp body 14 can be suspended from the rim of the first hole 15a on the upper cover 15. The clamp body 14 includes a protruding structure 14a, a plurality of hooks 14b, and a hub 14c in a conical shape for passing through a central hole of an optical disk to combine with a turntable of an optical disk drive so as to fix the optical disk. A third magnetic element 14d in the form of a circular ring shape is embedded into the outer ring of the clamp body 14, and the third magnetic element 14d can be a magnet or other component made of magnetic material. The third magnetic element 14d is deposed that it and the second magnetic element 16 face each other with the same magnetic polarity for generating a mutually repulsive force between the third magnetic element 14d and the second magnetic element 16.

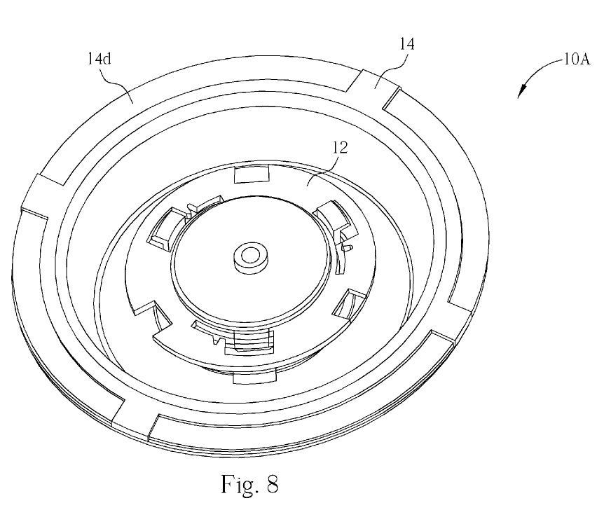

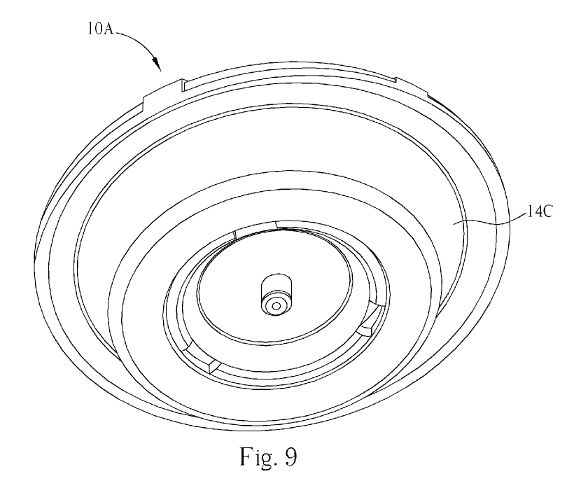

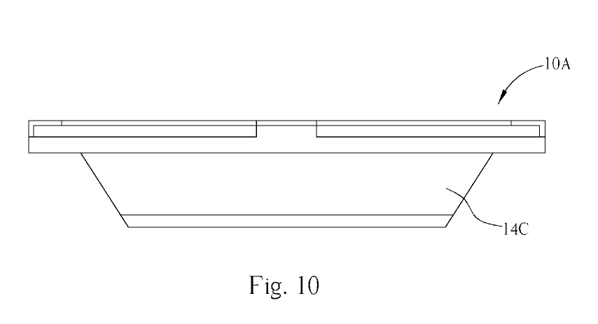

Please refer to FIG. 7 and FIG. 8. FIG. 8 is a top view of the clamping device 10A according to the present invention. The clamp yoke 12 and the first magnetic element 13 can be put together by aligning the second hole 12a of the clamp yoke 12 with the third hole 13a of the first magnetic element 13. The clamp yoke 12 and the first magnetic element 13 can be sheathed into the protruding structure 14a of the clamp body 14, and then a clamping device 10A can be assembled by wedging the plurality of slots 12b of the clamp yoke 12 into the plurality of hooks 14b of the clamp body 14. To learn more about the clamping mechanism of the present invention, please refer to FIG. 9 and FIG. 10. FIG. 9 is a bottom view of the clamping device 10 according to the present invention. FIG. 10 is a side view of the clamping device 10 according to the present invention.

Moreover, the plane of the rim of the first hole 15a is lower than the plane of the upper covering 15 and together with the upper plate 11 forming a chamber for deposing the clamping device 10A. Since the outer diameter of the clamping device 10A is greater than the diameter of the first hole 15a on the upper cover 15, the clamping device 10A can be positioned into the first hole 15a on the upper cover 15 and the clamp body 14 can be suspended from the rim of the first hole 15a. The second magnetic element 16 can be attached to the upper plate 11 by adhesive or other method, and then the upper plate 11 can be secured to and cover the first hole 15a on the upper cover 15 to prevent the clamping device 10A from departing from the optical disk drive when the optical disk drive is reading an optical disk.

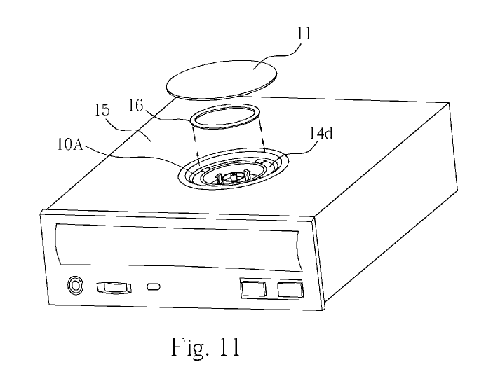

Please refer to FIG. 11. FIG. 11 is a diagram illustrating the mutually repulsive force between the clamping device 10A and the second magnetic element 16. Because the second magnetic element 16 and the third magnetic element 14d are positioned so that like poles face each other, a mutually repulsive force is generated between the third magnetic element 14d and the second magnetic element 16. Thus, after an optical disk on a tray is loaded into the optical disk drive, the turntable of the optical disk drive can be elevated to a specific position. At this time, a magnetic element of the turntable can attract the first magnetic element 13 of the clamping device 10A for fixing the optical disk, and the mutually repulsive force between the third magnetic element 14d and the second magnetic element 16 can make the turntable combine with the clamping device 10A. Even during external impact when the optical disk drive is reading the optical disk, the optical disk will not bounce nor become scraped or damaged.

In contrast to the prior art, the present invention can provide a real-time preload to the clamping device 10A with the mutually repulsive force between the third magnetic element 14d and the second magnetic element 16. Thus, even if the optical disk drive suffers significant external shock, the optical disk will not be damaged. Furthermore, in some embodiments, the first magnetic element 13 can be removed from the clamping device 10A since the second magnetic element 16 and the third magnetic element 14d have already provide enough mutually repulsive force to hold the disk firmly to the turntable.

Those skilled in the art will readily observe that numerous modifications and alterations of the device may be made while retaining the teachings of the invention. Accordingly, the above disclosure should be construed as limited only by the metes and bounds of the appended claims.

1. A non-contact clamping mechanism for use in an optical disk drive comprising a turntable, the non-contact clamping mechanism comprising:
an upper cover comprising a first hole;
a clamping device installed above the first hole of the upper cover for combining with the turntable so as to fix an optical disk;
an upper plate for covering the first hole of the upper cover to prevent the clamping device from departing from the optical disk drive when reading the optical disk; and
a magnetic element attached to the upper plate for providing a real-time preload to the clamping device.

2. The non-contact clamping mechanism of claim 1 wherein the clamping device comprises a first magnetic element for generating a mutually repulsive force between the magnetic element and the first magnetic element.

3. The non-contact clamping mechanism of claim 2 wherein the clamping device further comprises:
a clamp yoke;
a second magnetic element for combining with the clamp yoke; and
a clamp body for combining with the clamp yoke and the second magnetic element; and
wherein the first magnetic element is connected to the clamp body.

4. The non-contact clamping mechanism of claim 1 wherein the magnetic element is a magnet.

5. The non-contact clamping mechanism of claim 3 wherein the first magnetic element and the second magnetic element are magnets.

6. The non-contact clamping mechanism of claim 1 wherein the magnetic element is in the form of a circular ring.

7. The non-contact clamping mechanism of claim 1 wherein the first magnetic element and the second magnetic element are in the form of circular rings.

8. A non-contact clamping mechanism for use in an optical disk drive comprising a turntable, the non-contact clamping mechanism comprising:
an upper cover comprising a first hole;
a clamp yoke having a second hole;
a first magnetic element;
a clamp body installed above the first hole of the upper cover for combining with the clamp yoke and the first magnetic element and combining with the turntable so as to fix an optical disk;
a second magnetic element connected to the clamp body;
an upper plate for covering the first hole of the upper cover to prevent the clamp body from departing from the optical disk drive when reading the optical disk; and
a magnetic element attached to the upper plate for providing a real-time preload to the clamp body.

9. The non-contact clamping mechanism of claim 8 wherein the second magnetic element and the third magnetic element are deposed to generate a mutually repulsive force between the second magnetic element and the third magnetic element.

10. The non-contact clamping mechanism of claim 8 wherein the first magnetic element, the second magnetic element, and the third magnetic element are magnets.

11. The non-contact clamping mechanism of claim 8 wherein the first magnetic element, the second magnetic element, and the third magnetic element are in the form of circular rings.

12. A clamping device for use in a non-contact clamping mechanism to work with a turntable for fixing a disk in a disk drive, the disk drive comprising a magnetic element attached to an upper cover, the clamping device comprising:
a clamp body; and
a first magnetic element deposed in the clamp body for generating a mutually repulsive force between the magnetic element and the first magnetic element to provide a real-time preload to the clamping device.

13. The clamping device of claim 12, wherein the upper cover comprising:
a first hole for installing the clamping device; and
an upper plate for covering the first hole of the upper cover to prevent the clamping device from departing from the optical disk drive when in operating;
wherein the first magnetic element is attached to the upper plate.

14. The clamping device of claim 12 further comprising:
a clamp yoke; and
a second magnetic element for providing a magnetic force toward the turntable;
wherein the clamp yoke and the second magnetic element are deposed on the clamp body.

15. The clamping device of claim 12 wherein the magnetic element and the first magnetic element are magnets.

16. The clamping device of claim 14 wherein the second magnetic element is a magnet.
